(19) United States
(12) Patent Application Publication
(10) Pub. No.: US 2026/0095100 A1
(43) Pub. Date: Apr. 2, 2026

(54) SWITCHING CONVERTER WITH A SEMI-FLOATING ISOLATION RAIL FOR A TRANSISTOR DRIVER

(71) Applicant: TEXAS INSTRUMENTS INCORPORATED, Dallas, TX (US)

(72) Inventors: Florian Schimkat, Freising (DE); Stefan Herzer, Marzling (DE); Puneet Sareen, Freising (DE); Mahmoud Ghoneim, Eching (DE)

(21) Appl. No.: 19/090,701

(22) Filed: Mar. 26, 2025

Related U.S. Application Data
(60) Provisional application No. 63/700,870, filed on Sep. 30, 2024.

(51) Int. Cl. H02M 3/158; H02M 3/07

(52) U.S. Cl. CPC H02M 3/158; H02M 3/07

(57) ABSTRACT

An apparatus includes a first transistor having a control terminal. A second transistor couples in series with the first transistor. A driver has a first, second, and third driver terminals, and a driver output. The driver output couples to the control terminal. A capacitor has a first and second capacitor terminals. The first capacitor terminal couples to the first driver terminal, and the second capacitor terminal couples to the second driver terminal and to the first and second transistors. A third transistor has a first and second transistor terminals. The first transistor terminal couples to the first capacitor terminal, and the second transistor terminal couples to the third driver terminal. A fourth transistor has third and fourth transistor terminals. The third transistor terminal couples to the second transistor terminal.

### CROSS-REFERENCE TO RELATED APPLICATIONS

This application claims priority to U.S. Provisional Application No. 63/700,870 filed September 30, 2024, which is hereby incorporated by reference.

### BACKGROUND

Gallium nitride (GaN) field effect transistors (FETs) have relatively low drain-to-source capacitance compared to silicon FETs. As a result of the low drain-to-source capacitance, the switching speeds of GaN FETs may be higher than the switching speeds of comparably sized silicon FETs. The higher switching speed of GaN FETs results in lower switching losses compared to silicon FETs. Accordingly, using GaN FETs as the main switching transistors of a switching converter can improve the efficiency of switching power converters compared to the use of silicon FETs.

### SUMMARY

In one example, an apparatus includes a first transistor having a control terminal. A second transistor is coupled in series with the first transistor. A driver has a first driver terminal, a second driver terminal, a third driver terminal, and a driver output. The driver output is coupled to the control terminal. A capacitor has a first capacitor terminal and a second capacitor terminal. The first capacitor terminal is coupled to the first driver terminal, and the second capacitor terminal is coupled to the second driver terminal and to the first and second transistors. A third transistor has a first transistor terminal and a second transistor terminal. The first transistor terminal is coupled to the first capacitor terminal, and the second transistor terminal is coupled to the third driver terminal. A fourth transistor has a third transistor terminal and fourth transistor terminal. The third transistor terminal is coupled to the second transistor terminal.

In another example, an integrated circuit (IC) includes a first transistor having a control terminal and first transistor terminal. A driver has a first driver terminal, a second driver terminal, a third driver terminal, and a driver output. The driver output is coupled to the control terminal. A bootstrap capacitor is coupled across the first driver terminal and the first transistor terminal. The bootstrap capacitor is configured to provide the supply voltage to the driver. A second transistor has a second transistor terminal and a third transistor terminal. The second transistor terminal is coupled to the first driver terminal, and the third transistor terminal is coupled to the third driver terminal. The second transistor is of a first polarity. A third transistor has a fourth transistor terminal coupled to the third transistor terminal. The third transistor is of a second polarity.

In yet another example, an IC includes a p-type semiconductor substrate coupled to a ground terminal. An n-type layer is on the p-type semiconductor substrate. The p-type semiconductor substrate and n-type layer form a PN junction. A driver has a first driver terminal and a second driver terminal. A bootstrap capacitor has a first capacitor terminal and a second capacitor terminal. The first capacitor terminal is coupled to the first driver terminal, and the second capacitor terminal is coupled to the second driver terminal. A boot switch circuit has a third terminal and a fourth terminal. The third terminal is coupled to the bootstrap capacitor, and the fourth terminal is coupled to the n-type layer. The boot switch circuit is configured to: when the boot switch circuit is disabled, prevent a voltage at the n-type layer from being a negative voltage; and when the boot switch circuit is enabled, cause current to charge the bootstrap capacitor.

### BRIEF DESCRIPTION OF THE DRAWINGS

FIG. 1 is a circuit schematic of a switching converter, in an example.

FIG. 2 is a cross-sectional view of a semiconductor structure illustrating a PN junction associated with the semiconductor’s substrate that can become forward biased, in an example.

FIG. 3 is a circuit schematic illustrating an implementation of a boot switch control circuit, in an example.

FIG. 4 is a circuit schematic illustrating another example of a boot switch control circuit.

FIG. 5 is a circuit schematic illustrating a driver for controlling a high side (HS) transistor within the switching converter, in an example.

FIG. 6 is a circuit schematic illustrating a driver for controlling a low side (LS) transistor within the switching converter, in an example.

FIG. 7 is a circuit schematic illustrating another example of a driver for controlling the LS transistor within the switching converter.

FIG. 8 is a system diagram illustrating an example of automotive application for use of the switching converter of FIG. 1.

### DETAILED DESCRIPTION

The same reference numbers or other reference designators are used in the drawings to designate the same or similar (either by function and/or structure) features.

Some switching converters have a high side (HS) transistor coupled to a low side (LS) transistor at a switch terminal. Each of the HS and LS transistors has a corresponding driver to turn the respective transistor on and off. Further, some switching converters have a bootstrap capacitor coupled between the switch terminal and a “boost” terminal. The driver for the HS transistor has voltage supply terminals coupled to the boost and switch terminals and, accordingly, to the bootstrap capacitor. The bootstrap capacitor provides charge to power the HS transistor driver to turn on the HS transistor. The bootstrap capacitor may be charged to, for example, 5V relative to the switch terminal.

As noted above, GaN FETs can be operated at higher switching speeds and with lower switching losses than silicon FETs. Accordingly, some switching converters include GaN FETs as their HS and LS transistors for improved efficiency relative to the use of silicon FETs. However, parasitic inductance between the HS and LS transistors can result in voltage ringing at the switch terminal when the LS transistor turns on. The magnitude of the voltage ringing results, in part, from the relatively fast switching speed of the LS transistor. The relatively fast switching speeds of GaN FETs in particular results in large magnitude voltage ringing on the switch terminal of the switching converter. In one example, the switch terminal voltage may become as low as -20V as a result of the fast switching speed of an LS transistor implemented as a GaN FET.

Large negative voltages on the switch terminal during ringing caused by turning on the LS transistor can cause several problems. First, if attempting to charge the bootstrap capacitor while ringing is occurring at the switch terminal, the bootstrap capacitor may be overcharged. For example, instead of charging the bootstrap capacitor to +5V, the bootstrap capacitor may be charged to a voltage greater than +5V, which may impact the reliability of the circuitry to which the bootstrap capacitor is coupled. Second, any ringing at the switch terminal also results in ringing at the boost terminal through the bootstrap capacitor. If the switch terminal becomes more negative than -5V, the voltage on the boost terminal (which in this example is 5V higher than the switching terminal) will also be negative. In some semiconductor processes, the substrate of the integrated circuit on which the switching converter is fabricated is a p-type semiconductor substrate connected to ground. An n-type buried layer (NBL) may be over the p-type substrate for isolation reasons. In some switching converters, the NBL is coupled to the boost terminal. The combination of the p-type substrate and NBL forms a PN junction, which normally is reverse biased. However, during ringing the voltage at the boost terminal may become negative enough that the PN junction between the p-type substrate (ground) and the NBL (connected to the boost terminal) becomes forward biased. When the PN junction becomes forward biased, current flows through the p-type substrate into the NBL and may cause aberrant behavior in the IC. For example, the current injected into the substrate could also cause the bootstrap capacitor to be overcharged as well as cause severe ringing on the ground terminal, therefore, disturbing sensitive ground referenced circuitry in the controller of the switching converter which could lead to disturbances on the output voltage or even device failure. Voltage ringing at the switch terminal and the resulting problems are further described below. The example switching converter described herein addresses these problems.

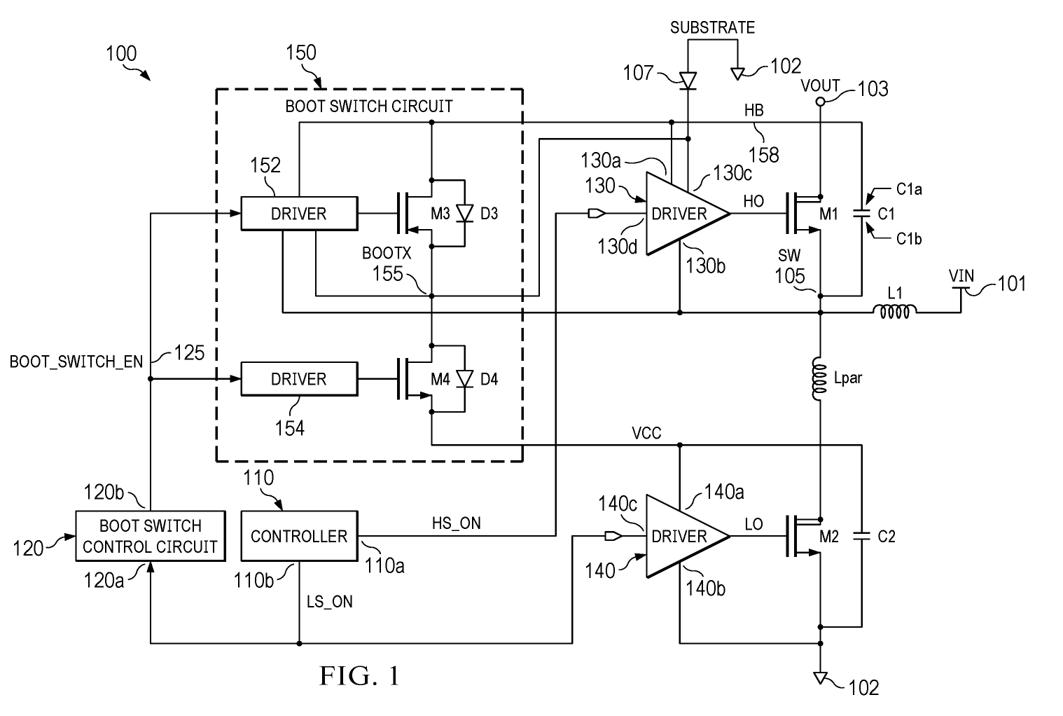

FIG. 1 is a schematic diagram of a boost converter 100 that addresses the aforementioned mentioned problems. The principles described with respect to FIG. 1 also apply to other types of switching converters such as buck converters, buck-boost converters, etc. Boost converter 100 includes transistors M1 and M2, capacitors C1 and C2, an inductor L1, a controller 110 (e.g., a pulse width modulation controller), a boot switch control circuit 120, drivers 130 and 140, and a boot switch circuit 150. In one example, transistor M1 is referred to as an HS transistor and transistor M2 is referred to as an LS transistor. In this example, the transistors M1 and M2 are n-channel FETs (NFETs) and may be GaN FETs. The drain of transistor M1 is coupled to a voltage terminal 103, e.g., an output voltage (VOUT) terminal. The source of transistor M1 is coupled to the drain of transistor M2 at a switch (SW) terminal 105. One terminal of inductor L1 is coupled to the SW terminal 105. The other terminal of inductor L1 is coupled to an input voltage (VIN) terminal 101. Inductance Lpar represents the parasitic inductance between the SW terminal 105 and the drain of the LS transistor (e.g., the parasitic inductance of a trace between transistors M1 and M2).

Driver 130 controls the on and off state of transistor M1, and driver 140 controls the on and off state of transistor M2. Driver 130 has an output coupled to the gate of transistor M1. Driver 130 also has an input 130d, and driver terminals 130a, 130b, and 130c. Driver 140 has an input 140c and has an output coupled to the gate of transistor M2. Driver 140 also has driver terminals 140a and 140b. Responsive to a control signal HS_ON at input 130d, driver 130 turns transistor M1 on and off. For example, a logic high for control signal HS_ON results in driver 130 turning transistor M1 on, and a logic low for control signal HS_ON results in driver 130 turning transistor M1 on. Similarly, a logic high for control signal LS_ON at the input 140c of driver 140 results in driver 140 turning transistor M2 on, and a logic low for control signal LS_ON results in driver 140 turning transistor M2 off.

Capacitor C1 also may be referred to as the bootstrap capacitor. Capacitor C1 has terminals C1a and C1b. Terminal C1a is coupled to driver terminal 130a. Terminal C1b is coupled to driver terminal 130b and to the source of transistor M1 and drain of transistor M2. The voltage at the HB terminal 158 is referred to as the HB voltage. The voltage of capacitor C1 is provided across driver terminals 130a and 130b to provide power to driver 130. The voltage of capacitor C1 is the difference between HB voltage and the voltage at the SW terminal 105. In one example, capacitor C1 is charged to 5V (HB voltage is 5V with respect to the SW terminal voltage) to power driver 130. Driver 140 is powered by a voltage VCC from voltage terminal VCC (e.g., an internal voltage rail) coupled to driver terminal 140a. Driver terminal 140b is coupled to ground terminal 102. In one example, VCC is 5V. Accordingly, both drivers 130 and 140 are powered by approximately the same voltage, e.g., 5V. The supply voltage for driver 140 is ground-based meaning voltage VCC is referenced with respect to ground. The supply voltage for driver 130, however, is SW terminal-based, meaning that voltage HB provided to driver 130 is 5V with respect to the SW terminal 105.

Controller 110 has an output 110a coupled to input 130d of driver 130 and also has an output 110b coupled to input 140c of driver 140. Controller 110 generates control signals HS_ON and LS_ON at outputs 110a and 110b, respectively, to turn on and off the respective transistor M1 and M2. During each switching cycle of boost converter 100, controller 110 asserts control signals HS_ON and LS_ON to turn on transistor M1 for part of the switching cycle and then to turn on transistor M2 during another portion of the switching cycle. When transistor M1 is on, transistor M2 is off. Similarly, when transistor M2 is on, transistor M1 is off.

Boot switch control circuit 120 includes an input 120a and an output 120b. The output 110b of controller 110 also is coupled to the input 120a of boot switch control circuit 120. Boot switch circuit 150 includes transistors M3 and M4 and respective drivers 152 and 154. Transistors M3 and M4 are coupled in series between terminal 158 and voltage terminal VCC. Transistors M3 and M4 may be silicon transistors. Transistors M3 and M4 are of opposite polarity. For example, in FIG. 1, transistor M3 is a p-channel field effect transistor (PFET), and transistor M4 is an NFET. The drain of transistor M3 is coupled to terminal 158, and the source of transistor M4 is coupled to the voltage terminal VCC. The source of transistor M3 is coupled to the drain of transistor M4 at a terminal 155. The voltage at terminal 155 is BOOTX. Terminal 155 is coupled to driver input 130c of driver 130. Drivers 152 and 154 have inputs coupled to the output 120b of boot switch control circuit 120, which generates signal BOOT_SWITCH_EN 125. In one example, a level shifter may be included to level shift the signal BOOT_SWITCH_EN 125 to an appropriate voltage given the supply voltage for driver 152. The level shifter may receive the BOOT_SWITCH_EN signal 125 from boot switch control circuit 120 and level shift that signal to be provided to the input of driver 152. In some examples, the level shifter is part of driver 152. In another example, boot switch control circuit 120 can generate the input signal to driver 152 in the voltage domain of driver 152. The output of driver 152 is coupled to the gate of transistor M3, and the output of driver 154 is coupled to the gate of transistor M4. Drivers 152 and 154 turn on and off their respective transistors M3 and M4 based on signal BOOT_SWITCH_EN 125 from boot switch control circuit 120.

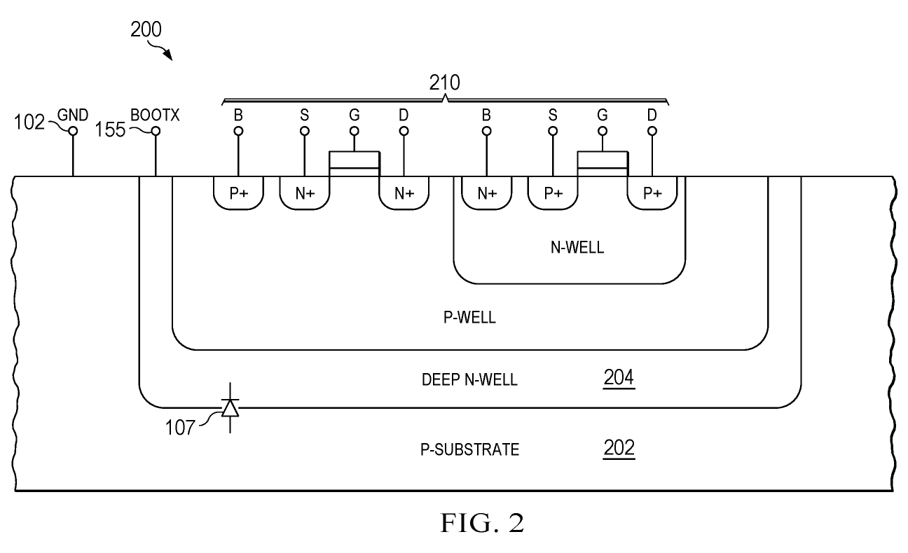

Some or all of the components of boost converter 100 in FIG. 1 may be fabricated on an integrated circuit. In some examples, inductor L1 is external to such integrated circuit, but in other examples, inductor L1 is fabricated on the integrated circuit. As described below with reference to FIG. 2, diode 107 represents a parasitic PN junction (referred to herein as PN junction 107) associated with the substrate on which the integrated circuit is fabricated.

FIG. 2 is a cross-sectional view of a semiconductor structure 200 representing a portion of the integrated circuit on which boost converter 100 may be fabricated. The semiconductor structure 200 includes a p-type substrate 202. An n-type buried layer (NBL) 204 is over the p-type substrate 202. Additional layers and materials are over NBL 204. Reference numeral 210 identifies one or more transistors (e.g., transistors M3 and M4 shown in FIG. 1) and drivers 130 and 152 which may be formed on the semiconductor structure 200. The p-type substrate 202 and NBL 204 form the PN junction 107. In some examples, the p-type substrate 202 is coupled to the ground terminal 102.

NBL 204 is coupled to terminal 155 and, accordingly, is at voltage BOOTX. During normal operation of boost converter 100, the BOOTX voltage is equal to or greater than 0V. Accordingly, the PN junction 107 is normally reversed biased, and current does not conduct current from the p-type substrate 202 to the NBL 204. This configuration allows fast switching of the transistors M1 and M2 with the HB terminal 158 and SW terminal 105 ringing below ground without overcharging the capacitor C1 and without disturbing the device ground as no substrate current is injected via the PN junction 107.

Unfortunately, PN junction 107 can become forward biased when transistor M2 is initially turned on. The combination of parasitic inductance Lpar and a relatively large change in current (di/dt) through transistor M2 and parasitic inductance Lpar to inductor L1 may result in voltage ringing at the SW terminal 105. Eventually, the voltage ringing at the SW terminal 105 settles and for the rest of the time that transistor M2 is on, the voltage at the SW terminal 105 is approximately 0V. During the voltage ringing at the SW terminal 105, the HB terminal 158 also experiences ringing through transistor C1. In some switching converters (e.g., not the boost converter 100 of FIG. 1), the HB terminal 158 is coupled to the NBL 204. Accordingly, the voltage at the SW terminal 105 may be a large enough negative voltage that the HB voltage may be negative enough to cause the PN junction 107 to be forward biased. For example, if capacitor C1 is charged to 5V, then HB voltage will be 5V greater than the voltage at the SW terminal 105. If the voltage at the SW terminal 105 is -20V during ringing, then the HB voltage is -15V which strongly forward biases PN junction 107. With PN junction 107 forward biased, current flows from ground, through the p-type substrate 202 into the NBL 204 which may result in problems such as those described above.

The boot switch control circuit 120 and the boot switch circuit 150 of FIG. 1 function to address both of these problems. During each switching cycle, controller 110 asserts control signal HS_ON to a logic state to cause driver 130 to turn on transistor M1. While transistor M1 is on, boot switch control circuit 120 asserts control signal BOOT_SWITCH_EN 125 to a logic state (e.g., logic low) to force transistors M3 and M4 to be off. Accordingly, transistors M3 and M4 are off while transistor M1 is on. Controller 110 then asserts control signals HS_ON and LS_ON to turn off transistor M1 and turn on transistor M2. With transistors M3 and M4 still off (boot switch control circuit 120 has not yet turned on transistors M3 and M4), current from voltage terminal VCC does not flow through the channels of transistors M3 and M4 to charge capacitor C1. Further, the reverse polarity orientation of body diodes D3 and D4 between the HB terminal 158 and the VCC terminal prevents both body diodes from being forward biased and, accordingly, current also does not flow through the body diodes D3 and D4 to capacitor C1. Boot switch control circuit 120 continues to maintain transistors M3 and M4 in an off state during at least most of the ringing time period on the SW terminal 105, referred to as a blanking period. By preventing capacitor C1 from being charged during the blanking period while voltage ringing is occurring on the SW terminal 105, capacitor C1 is not overcharged. When the voltage ringing at the SW terminal 105 mostly or fully subsides (the blanking period is over), boot switch control circuit 120 asserts the control signal BOOT_SWITCH_EN 125 to a logic state (e.g., logic high) whereby drivers 152 and 154 respond by turning on transistors M3 and M4. With transistors M3 and M4 on, current flows through from the terminal VCC to charge capacitor C1. With capacitor C1 charged, the voltage across capacitor C1 can subsequently be used to power driver 130 to turn on transistor M1 when controller 110 asserts control signal HS_ON to request that driver 130 turn on transistor M1 during the next switching cycle.

The configuration of transistors M3 and M4 also avoids PN junction 107 from becoming forward biased. As shown in FIG. 1, the HB terminal 158 is coupled to driver terminal 130a and not directly to driver terminal 130c. Accordingly, the HB terminal 158 is not directly connected to the cathode of the PN junction 107 and thus not connected to the NBL 204. To enable operation of driver 130, however, the voltage at driver terminal 130c should be approximately equal to the HB voltage. As described above, when controller 110 asserts control signal LS_ON to initially turn on transistor M2, driver 140 turns on transistor M2 and boot switch control circuit 120 continues for the blanking period (e.g., when ringing is occurring on the SW terminal 105) to maintain transistors M3 and M4 in an off state. When transistor M2 is on, driver 130 need not be enabled. With transistor M3 off, the cathode of PN junction 107 is at voltage BOOTX. Voltage BOOTX may float between voltages HB and VCC due to the capacitive divider represented by the drain-to-source capacitance of transistors M3 and M4. The body diode D4 of transistor M4 ensures that voltage BOOTX will not drop more than one diode voltage drop (e.g., 1V) below voltage VCC. For example, if VCC is +5V, then voltage BOOTX will be no lower than approximately +4V. Accordingly, even if the voltage at the SW terminal 105 falls, for example, to -20V during ringing when transistor M2 is turned on thereby resulting in the HB voltage being -15V, the cathode of the PN junction 107 will advantageously remain at +4V and the PN junction will remain reverse biased.

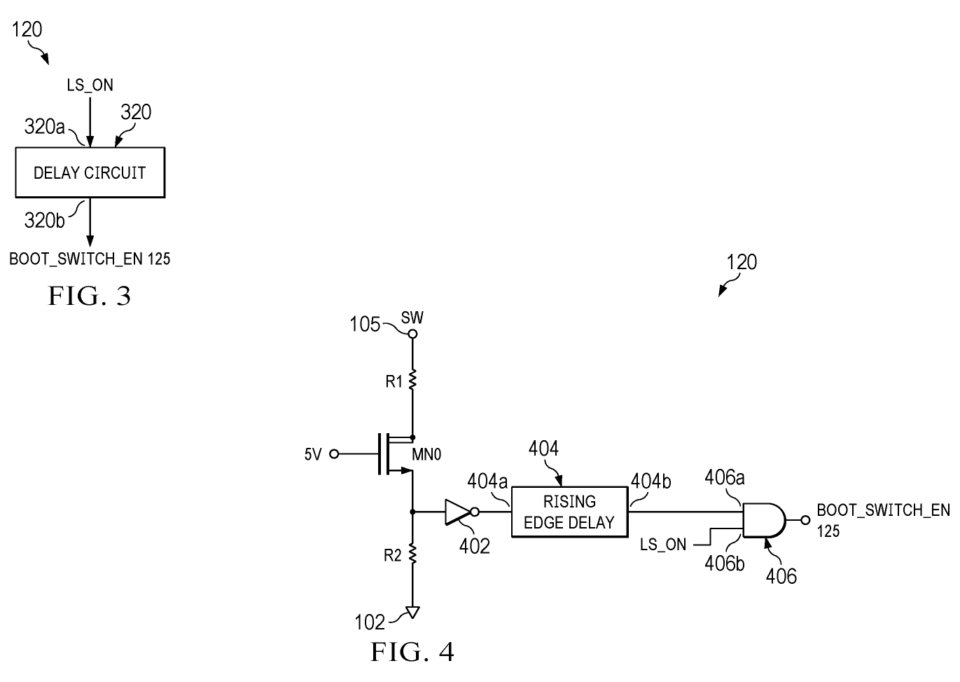

FIG. 3 is an example implementation of boot switch control circuit 120. In this example, boot switch control circuit 120 includes a delay circuit 320 having an input 320a and an output 320b. The control signal LS_ON is provided to input 320a. The delay circuit 320 generates a delayed version of control signal LS_ON at its output 320b as the control signal BOOT_SWITCH_EN 125. The time delay implemented by delay circuit 320 is equal or greater than the blanking period. The blanking period may be determined apriori by way of simulation or testing. In one example, the delay is 20ns. Accordingly, after the blanking period following the assertion (e.g., logic high) of signal LS_ON, boot switch control circuit 120 asserts control signal BOOT_SWITCH_EN 125 to turn on transistors M3 and M4, and thereby avoids ringing at the SW terminal 105 from forward biasing the PN junction 107 and avoids capacitor C1 from being overcharged.

FIG. 4 is a circuit schematic of another example implementation of boot switch control circuit 120. Boot switch control circuit 120 in FIG. 4 includes resistors R1 and R2, transistor MN0, an inverter 402 (or a Schmitt trigger), a rising edge delay circuit 404, and an AND gate 406. In this example, transistor MN0 is an NFET. One terminal of resistor R1 is coupled to the SW terminal 105, and the other terminal of resistor R1 is coupled to the drain of transistor MN0. A fixed voltage (e.g., 5V) is provided to the gate of transistor MN0. The fixed gate voltage for transistor MN0 is high enough to ensure that the gate-to-source voltage (Vgs) for transistor MN0 is larger than the threshold voltage (Vt) of transistor MN0 (Vgs > Vt). One terminal of resistor R2 is coupled to the source of transistor MN0 and to an input of inverter 402. The other terminal of resistor R2 is coupled to the ground terminal 102. The output of inverter 402 is coupled to an input 404a of rising edge delay circuit 404. The output 404b of rising edge delay circuit 404 is coupled to an input of AND gate 406. The control signal LS_ON is provided to the other input 406b of AND gate 406. The output of AND gate 406 provides the control signal BOOT_SWITCH_EN 125.

Rising edge delay circuit 404 produces a delayed rising edge signal at its output 404b in response to a rising edge of a signal at its input 404a. The delay implemented for the rising edge delay circuit 404 is greater than the period of the ringing frequency (e.g., determined experimentally or through simulation). The rising edge delay circuit 404 produces the delayed output rising edge as long as the input signal remains at the logic high level for at least the delay period of time implemented by the rising edge delay circuit.

The voltage at the SW terminal 105 is at approximately voltage VOUT when transistor M1 is on. In this state, enough current flows through transistor MN0 such that the voltage across resistor R2 is high enough to be sensed by inverter 402 as a logic high. With the input of inverter 402 at logic high level, the output of inverter 402 and the input of 404a of rising edge delay 404 are logic low. Accordingly, the output 404b of rising edge delay 404 and the input 406a of AND gate 406 are logic low and the signal BOOT_SWITCH_EN 125 is logic low.

Then, when controller 110 turns off transistor M1 and turns on transistor M2, the voltage at the SW terminal 105 begins to fall as ringing at the SW terminal 105 begins to occur during the blanking period. When the voltage at the SW terminal falls to 0V, current through transistor MN0 ceases or falls to a low enough level that the voltage across resistor R2 is sensed by inverter 402 as a logic low. A logic low at the input of inverter 402 results in a rising edge at the input of rising edge delay 404. However, during ringing at the SW terminal 105, the voltage at the SW terminal will quickly increase to a level that that causes a falling edge at the input of rising edge delay circuit 404. The width of the resulting pulse, while the input to rising edge delay circuit 404 is logic high is shorter than the delay configured into rising edge delay circuit 404, and the output 404b of rising edge delay circuit 404 remains logic low. However, when the ringing subsides, the input to inverter 402 will remain logic low for more than the delay time period configured into rising edge delay circuit 404, and rising edge delay circuit 404 then provides a logic high level at its output 404b. With both LS_ON and the output signal from rising edge delay circuit 404 being logic high, the signal BOOT_SWITCH_EN 125 is forced logic high by AND gate 406.

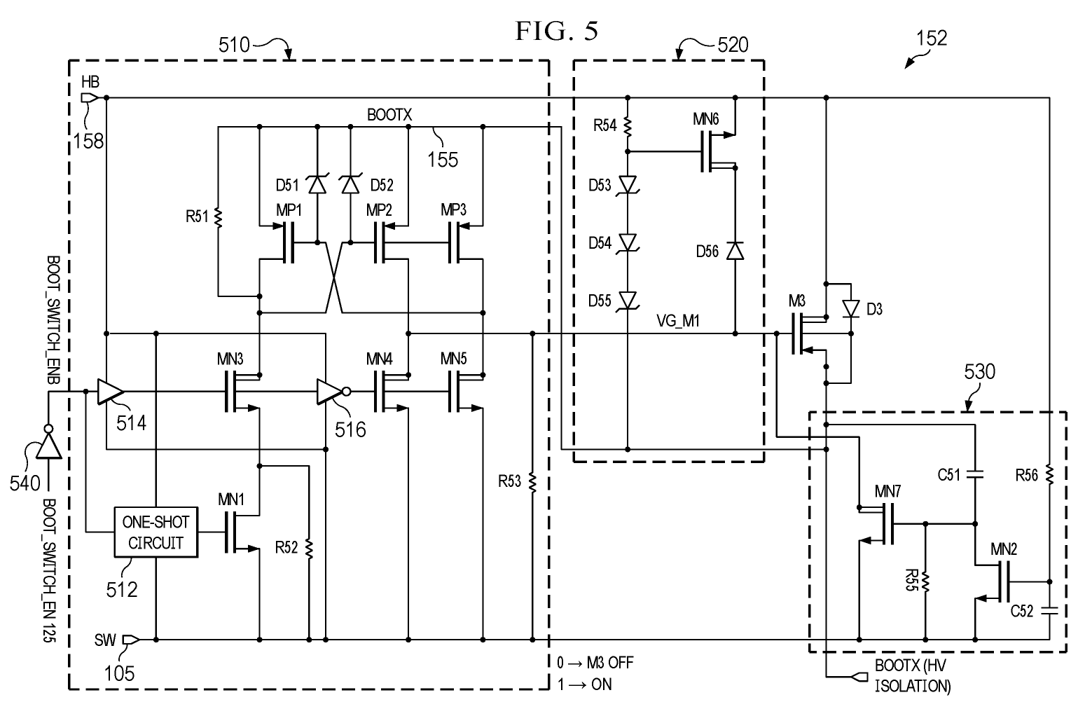

FIG. 5 is a schematic diagram of driver 152, in an example. Driver 152 includes a level shifter circuit 510, a clamp circuit 520, a startup circuit 530, and an inverter 540. Level shifter circuit 510 shifts the voltage of the control signal BOOST_SWITCH_EN to a sufficient voltage level for turning on and off transistor M3. Level shifter circuit 510 includes resistors R51, R52, and R53, Zener diodes D51 and D52, transistors MP1, MP2, MP3, MN1, MN3, MN4, and MN5, a one-shot circuit 512, a buffer 514, and an inverter 516. Transistors MP1, MP2, and MP3 are PFETs, and transistors MN1, MN3, MN4, and MN5 are NFETs. Zener diode D51 is coupled across the source and gate terminals of transistor MP1, and Zener diode D52 is coupled across the source and gate terminals of transistor MP2. Zener diodes D51 and D52 protect transistors MP1 and MP2. For example, Zener diodes D51 and D52 prevent the gate-to-source voltages (Vgs) of transistors MP1 and MP2, respectively, from exceeding a safe operating range for those transistors.

The sources of transistors MP1-MP3 are coupled to terminal 155. Resistor R51 is coupled across the source and drain terminals of transistor MP1. The drain of transistor MP1 is coupled to the drain of transistor MN3. The drain of transistor MN1 is coupled to the source of transistor MN3. The source of transistor MN1 is coupled to the SW terminal 105. Resistor R52 is coupled between the drain of transistor MN1 and the SW terminal 105. Similarly, transistors MP2 and MN4 are coupled in series between terminal 155 and the SW terminal 105. The drains of transistors MP2 and MN4 are coupled to the gate of transistor M3. Transistors MP3 and MN5 also are coupled in series between terminal 155 and the SW terminal 105. The gate of transistor MP1 is coupled to the drains of transistors MP3 and MN5. The gate of transistor MP2 is coupled to the drains of transistors MP1 and MN3. Resistor R53 is coupled between the gate of transistor M3 and the SW terminal 105.

Inverter 540 receives the control signal BOOST_SWITCH_EN and produces a logical inverse signal BOOT_SWITCH_ENB at its output, which is coupled to an input of buffer 514 and to an input of one-shot 512. Through buffer 514, signal BOOT_SWITCH_ENB is provided to the gate of transistor MN3. Inverter 516 inverts signal BOOT_SWITCH_ENB and provides the inverted signal (logically equivalent to BOOT_SWITCH_EN) to the gates of transistors MN4 and MN5.

Responsive to signal BOOT_SWITCH_EN 125 being logic low and BOOT_SWITCH_ENB being logic high, transistors MN3 and, via one-shot circuit 512, MN1 turn on, which pulls the voltage at the gates of transistors MP2 and MP3 downward thereby turning on transistors MP2 and MP3. With transistor MP2 being on, the gate of transistor M3 is pulled upward to approximately the BOOTX voltage. Because the source of transistor M3 also receives the BOOTX voltage, the Vgs of transistor M3 is approximately 0V thereby forcing transistor M3 to be off. Transistor MP3 being on also forces transistor MP1 to be off. Further, signal BOOT_SWITCH_ENB being logic high results in, through inverter 516, transistors MN4 and MN5 being off. With transistor MN1 being controlled by a pulse from one-shot circuit 512, transistor MN1 is only turned on for a short time that is sufficient to turn on transistors MP2 and MP3 and turn off transistors M3 and MP1. While transistor MN1 is turned on, a direct current (DC) current flows through Zener diode D52 and transistors MN3 and MN1. Once the one-shot pulse has ended, transistor MN1 turns off and the DC current flowing through Zener diode D52 and transistor MN3 is now significantly reduced as it is defined by resistor R52. Resistor R52 is sized to just hold the state of the driver and keep transistors MP2 and MP3 turned on. Responsive to signal BOOT_SWITCH_EN 125 being logic high and BOOT_SWITCH_ENB being logic low, transistor MN3 is off and transistors MN4 and MN5 are on. Transistor MN4 being on pulls the voltage at the gate of transistor M3 downward thereby resulting in transistor M3 being on. Transistor MN4 also pulls down the gate of MP1 resulting in transistor MP1 being on and pulling up the gates of transistors MP2 and MP3 which turns off transistors MP2 and MP3.

As described above, terminal 155 is coupled to NBL 204. Because NBL 204 is at the BOOTX voltage, PN junction 107 can become forward biased as described above. During most or all of the ringing at the SW terminal 105 and, through capacitor C1, at the HB terminal 158, boot switch control circuit 120 turns transistor M3 off. Transistor M3 being off has several advantages as described above, current does not flow to charge capacitor C1 which otherwise may overcharge capacitor C1 if the voltage at the SW terminal 105 becomes negative during ringing. Second, a negative voltage at the HB terminal 158 will reverse bias the body diode D3 of transistor M3 precluding voltage BOOTX from being negative thereby preventing PN junction 107 from being forward biased. Accordingly, transistor M3 and its body diode D3 electrically decouples the HB terminal 158 from the BOOTX terminal 155 during most or all of the ringing on the HB terminal 158. After the ringing has mostly or completely subsided, boot switch control circuit 120 turns transistor M3 on thereby electrically coupling the HB voltage to the BOOTX voltage to enable operation of driver 152.

Clamp circuit 520 ensures that the drain-to-source voltage of transistor M3 does not exceed its rated maximum (e.g., 20V). Clamp circuit 520 includes transistor MN6, resistor R54, Zener diodes D53, D54, and D55, and diode D56. Zener diodes D53-D55 are coupled in series between the gate of transistor MN6 and the source of transistor M3. Resistor R54 is coupled between the HB terminal 158 and the string of Zener diodes D53-D55. The gate of transistor MN6 is coupled to resistor R54 and the anode of Zener diode D53. The source of transistor MN6 is coupled to the HB terminal 158, and the drain of transistor MN6 is coupled to the cathode of diode D56. The anode of diode D56 is coupled to the gate of transistor M3. In one example, the forward bias voltage of the Zener diodes is 6V. Accordingly, when the voltage difference between HB and BOOTX is less than 18V, the Zener diodes are off and transistor MN6 is off. If the voltage difference between HB and BOOTX exceeds 18V, the Zener diodes turn on, which results in transistor MN6 turning on as well. Turning on transistor MN6 ensures transistor M3 is on, while the drain-to-source voltage of transistor M3 is clamped as a result of the forward bias voltages of the Zener diodes D53-D55.

Startup circuit 530 ensures that at power-up of boost converter 100, transistor M3 turns on to charge capacitor C1. Startup circuit 530 includes transistors MN2 and MN7, resistors R55 and R56 and capacitors C51 and C52. The gate of transistor MN2 is coupled to resistor R56 and capacitor C52. Resistor R56 and capacitor C52 form a low-pass filter for the HB voltage. Capacitor C52 is coupled between the gate and source of transistor MN2. Capacitor C51 is coupled between the drain of transistor MN2 and the source of transistor M3. The drain of transistor MN2 is also coupled to the gate of transistor MN7. Resistor R55 is coupled between the gate of transistor MN7 and ground. At power-up of boost converter 100, the capacitor C1 is fully discharged, resulting in the HB voltage being equal to the voltage at the SW terminal 105 and MN2 having a gate-to-source voltage of 0V. Accordingly, transistor MN2 is off at power-up. To charge capacitor C1, transistor M2 is turned on, thereby pulling the voltage at the SW terminal 105 to ground. Once the voltage at the SW terminal reaches ground, transistor M4 is enabled and the BOOTX voltage becomes VCC, which capacitively pulls up the gate of transistor MN7 via capacitor C51. As a result, transistors MN7 turns on, which pulls down the gate of M3 to a level at which transistor M3 turns on thereby ensuring that the HB voltage becomes approximately equal to VCC.

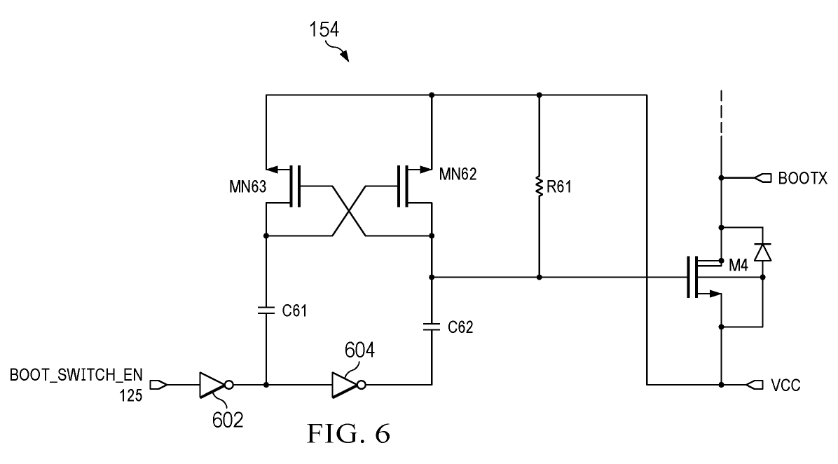

FIG. 6 is a circuit schematic of another example of driver 154. In this example, driver 154 includes transistors MN62 and MN63, resistor R61, capacitors C61 and C62 and inverters 602 and 604. In this example, driver 154 is a bootstrap circuit which level-shifts the voltage of control signal BOOT_SWITH_EN 125 to a suitable voltage for turning transistor M4 on and off. Transistors MN63 and MN62 are cross-coupled with the gate of transistor MN63 coupled to the drain of transistor MN62 and to the gate of transistor M4. Further, the gate of transistor MN62 is coupled to the drain of transistor MN63. The sources of transistors MN62 and MN63 are coupled together. Resistor R61 is coupled across the source and drain and of transistor MN62. Inverter 602 receives control signal BOOT_SWITCH_EN 125 at its input. The output of inverter 602 is coupled to the input of inverter 604 and to a terminal of capacitor C61. The other terminal of capacitor C61 is coupled to the gate of transistor MN62. A terminal of capacitor C62 is coupled to the output of inverter 604, and the other terminal of capacitor C62 is coupled to the gate of transistor MN63.

Responsive to the control signal BOOT_SWITCH_EN 125 being logic high, the output of inverter 602 is logic low and the output of inverter 604 is logic high. With the inverter outputs in this state, transistor MN63 is on, transistor MN62 is off, and transistor M4 turns on. Responsive to the control signal BOOT_SWITCH_EN 125 being logic low, the output of inverter 602 is logic high and the output of inverter 604 is logic low. With the inverter outputs in this state, transistor MN63 is off, transistor MN62 is on, and transistor M4 turns off.

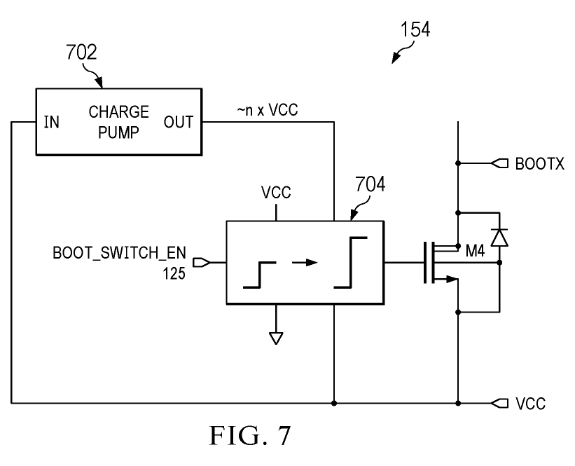

FIG. 7 is a circuit schematic of another example of driver 154. In this example, driver 154 includes a charge pump 702 coupled to a level shifter 704. Charge pump 702 receives VCC as an input voltage and produces and output voltage that is n x VCC. In one example, n is 2 and, accordingly, charge pump 702 produces an output voltage that is twice that of VCC. In response to a rising edge of control signal BOOT_SWITCH_EN 125, level shifter 704 level shifts the voltage at the output of charge pump 702 to provide the gate voltage for transistor M4 to thereby turn on transistor M4. In response control signal BOOT_SWITCH_EN 125 being logic low, level shifter 704 generates the gate voltage for transistor M4 at VCC to turn off transistor M4.

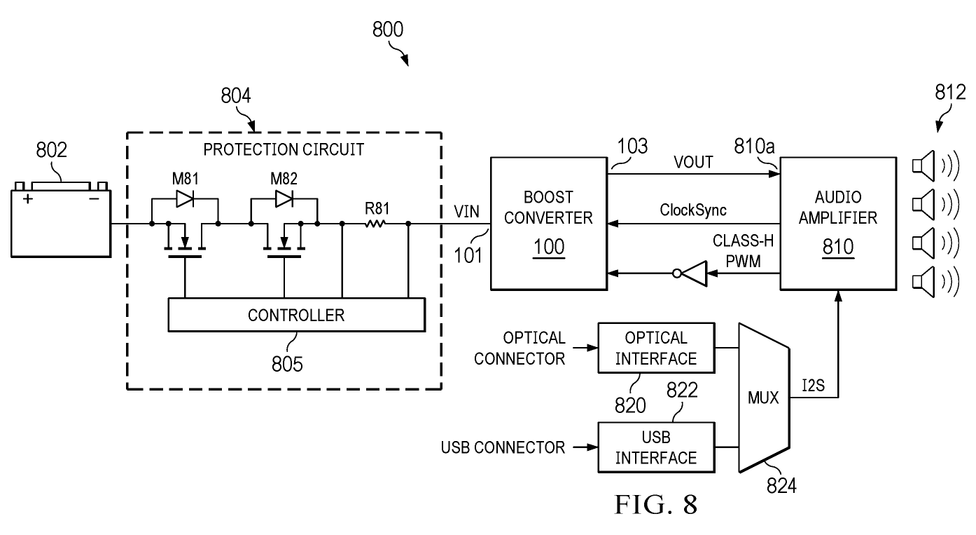

FIG. 8 is a diagram of a system 800 in which boost converter 100 may be used. System 800 may be used in an automobile. System 800 includes a battery 802 (e.g., the automobile’s 12V battery), a protection circuit 804, the boost converter 100, an audio amplifier 810, speakers 812, an optical interface 820, a universal serial bus (USB) audio interface 822, and a multiplexer 824. Protection circuit 804 includes transistors M81 and M82, a controller 805, and a resistor R81. To turn power on to boost converter 100, controller 805 turns on transistors M81 and M82 to allow current to flow from battery 802 to boost converter 100. The voltage terminal 103 of boost converter is coupled to a voltage input 812a of audio amplifier 810. In one example, audio amplifier 810 is class-D amplifier. Audio may be provided in any of multiple sources such as via an optical connector or a USB connector. Optical interface 820 couples the optical connector to one input of multiplexer 824, and USB interface 822 couples the USB connector to another input of multiplexer 824. The output of multiplexer 824 is coupled to an input 810b of audio amplifier 810. One or more speakers 812 are coupled to and driven by audio amplifier 810.

In the example of FIG. 1, boost converter 100 includes transistor M4 and its corresponding driver 154. In another example, a diode is included instead of transistor, and driver 154 is not included. The polarity of the diode is the same as body diode D4 of transistor M4. The anode of the diode would be coupled to VCC and the cathode of the diode would be coupled to the source of transistor M3.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT – e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor’s control input and its current terminals. In the context of a FET, the control input is the gate, and the current terminals are the drain and source. In the context of a BJT, the control input is the base, and the current terminals are the collector and emitter. The gate, source, and drain of a FET and base, collector, and emitter of a BJT are terminals of the transistor.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor’s body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/- 10 percent of that parameter or, if the parameter is zero, a reasonable range of values around zero.

Modifications are possible in the described examples, and other examples are possible, within the scope of the claims.

What is claimed is:

1. An apparatus, comprising:
a first transistor having a control terminal;
a second transistor coupled in series with the first transistor;
a driver having a first driver terminal, a second driver terminal, a third driver terminal, and a driver output, the driver output coupled to the control terminal;
a capacitor having a first capacitor terminal and a second capacitor terminal, the first capacitor terminal coupled to the first driver terminal, and the second capacitor terminal coupled to the second driver terminal and to the first and second transistors;
a third transistor having a first transistor terminal and a second transistor terminal, the first transistor terminal coupled to the first capacitor terminal, and the second transistor terminal coupled to the third driver terminal; and
a fourth transistor having a third transistor terminal and fourth transistor terminal, the third transistor terminal coupled to the second transistor terminal.

2. The apparatus of claim 1, wherein the third transistor is of opposite polarity as the fourth transistor.

3. The apparatus of claim 1, wherein:
the third transistor is a p-channel field effect transistor; and
the fourth transistor is an n-channel field effect transistor.

4. The apparatus of claim 1, wherein the driver is a first driver, the control terminal is a first control terminal, the second transistor has a second control terminal, the third transistor has a third control terminal, the fourth transistor has a fourth control terminal, and the apparatus further comprises:
a second driver having an input and having a second driver output coupled to the second control terminal, the input configured to receive a control signal; and
a delay circuit having a delay circuit input and a delay circuit output, the delay circuit input coupled to the input of the second driver, and the delay circuit output coupled to the third and fourth control terminals.

5. The apparatus of claim 1, wherein the driver is a first driver, the control terminal is a first control terminal, the second transistor has a second control terminal, the third transistor has a third control terminal, the fourth transistor has a fourth control terminal, and the apparatus further comprises:
a second driver having an input and having a second driver output coupled to the second control terminal, the input configured to receive a control signal; and
a control circuit having a first control circuit input, a second control circuit input, and a control circuit output, the first control circuit input coupled to the second driver terminal, the first transistor, and the second transistor, the second control circuit input coupled to the input of the second driver, and the control circuit output coupled to the third control terminal and to the fourth control terminal.

6. The apparatus of claim 1, further comprising:
a p-type semiconductor substrate coupled to a ground terminal; and
an n-type layer on the p-type semiconductor substrate, the n-type layer coupled to the third driver terminal.

7. The apparatus of claim 1, wherein the first and second transistors are gallium nitride transistors.

8. The apparatus of claim 7, wherein the third and fourth transistors are silicon transistors.

9. The apparatus of claim 1, further comprising an inductor coupled to the second capacitor terminal, the second driver terminal, the first transistor, and the second transistor.

10. The apparatus of claim 1, wherein the apparatus is a boost converter.

11. A switching converter, comprising:
a first transistor having a control terminal and a first transistor terminal;
an inductor coupled to the first transistor terminal;
a driver having a first driver terminal, a second driver terminal, a third driver terminal, and a driver output, the driver output coupled to the control terminal;
a bootstrap capacitor coupled across the first driver terminal and the first transistor terminal, the bootstrap capacitor configurable to provide a voltage to the driver;
a second transistor having a second transistor terminal and a third transistor terminal, the second transistor terminal coupled to the first driver terminal, and the third transistor terminal coupled to the third driver terminal, the second transistor being of a first polarity; and
a third transistor having a fourth transistor terminal coupled to the third transistor terminal, the third transistor being of a second polarity.

12. The switching converter of claim 11, wherein the first transistor is a gallium nitride transistor.

13. The switching converter of claim 12, further comprising a fourth transistor coupled between the first transistor terminal and a ground terminal.

14. The switching converter of claim 13, wherein the fourth transistor is a gallium nitride transistor.

15. The switching converter of claim 13, further comprising a circuit configured to:
turn off the second and third transistors when the first transistor is on; and
turn on the second and third transistors after a delay following the fourth transistor turning on.

16. The switching converter of claim 11, wherein the second transistor is a p-channel field effect transistor, and the third transistor is an n-channel field effect transistor.

17. An integrated circuit (IC), comprising:
a p-type semiconductor substrate;
an n-type layer on the p-type semiconductor substrate, the p-type semiconductor substrate and n-type layer forming a PN junction;
a driver having a first driver terminal and a second driver terminal;
a bootstrap capacitor having a first capacitor terminal and a second capacitor terminal, the first capacitor terminal coupled to the first driver terminal, and the second capacitor terminal coupled to the second driver terminal; and
a boot switch circuit having a third terminal and a fourth terminal, the third terminal coupled to the bootstrap capacitor, and the fourth terminal coupled to the n-type layer, the boot switch circuit configurable to:
prevent a voltage at the n-type layer from being a negative voltage in a first state of the boot switch circuit; and
cause current to charge the bootstrap capacitor in a second state of the boot switch circuit.

18. The IC of claim 17, wherein the boot switch circuit includes a fifth terminal coupled to a power terminal, and the boot switch circuit comprises a first transistor coupled in series with a second transistor between the third terminal and the fourth terminal.

19. The IC of claim 18, wherein the first transistor is of opposite polarity as the second transistor.

20. The IC of claim 18, wherein:
the first transistor has a first transistor terminal coupled to the third terminal, the first transistor is a p-channel field effect transistor; and
the second transistor has a second transistor terminal coupled to the fifth terminal, the second transistor is an n-channel field effect transistor.

21. The IC of claim 17, wherein the driver has an output, and the IC further comprises:
a first gallium nitride transistor having a first transistor terminal and a first control terminal, the first control terminal coupled to the output of the driver; and
a second gallium nitride transistor having a second transistor terminal coupled to the first transistor terminal, the second capacitor terminal coupled, and the second driver terminal.
